(19) United States
(12) Patent Application Publication
(10) Pub. No.: US 2026/0075358 A1
(43) Pub. Date: Mar. 12, 2026

(54) PROVIDING MONITOR AUDIO MIXES TO PERFORMERS WITHIN A VENUE

(71) Applicant: Sphere Entertainment Group, LLC, New York, NY (US)

(72) Inventors: Stuart ELBY, Westport, CT (US); Erik HOCKMAN, New York, NY (US)

(73) Assignee: Sphere Entertainment Group, LLC, New York, NY (US)

(21) Appl. No.: 18/830,188

(22) Filed: Sep. 10, 2024

(51) Int. Cl. H04R 1/40; H04R 3/12; H04W 4/029

(52) U.S. Cl. CPC H04R 1/403; H04R 3/12; H04W 4/029

(57) ABSTRACT

Systems, methods, and apparatuses can generate one or more monitor audio mixes that are associated with an event being hosted by a real-world venue. These systems, methods, and apparatuses can determine one or more locations of one or more real-world performers within the real-world venue. These systems, methods, and apparatuses can determine one or more parameters, characteristics, and/or attributes for one or more soundwaves that need to be emitted by one or more real-world monitor speaker arrays to provide the one or more monitor audio mixes to one or more locations. These systems, methods, and apparatuses can configure the one or more soundwaves in accordance with these parameters, characteristics, and/or attributes. These systems, methods, and apparatuses can provide these soundwaves having these parameters, characteristics, and/or attributes configured to the one or more monitor speaker arrays to generate the one or more monitor audio mixes to the one or more locations of one or more real-world performers within the real-world venue.

### BACKGROUND

Monitor audio mixes represent customized audio mixes that are sent to performers while these performers are performing an event being hosted by a venue. These monitor audio mixes help the performers to stay synchronized with one another and to maintain proper timing and pitch. These monitor audio mixes are tailored to meet the specific needs of each performer, allowing them to hear themselves and other important elements of the event clearly. For example, a singer often includes more vocals in their monitor mix while a drummer might want to include more bass and snare. Conventionally, monitor audio mixes are provided to the performers using in-ear monitors (IEMs). However, these IEMs can isolate the performers from the ambient sounds of the audience; cause ear fatigue, and potentially harm hearing, when used at high volumes; experience technical connectivity issues disrupting the performer's ability to hear themselves; and/or can simply fall out of the performer's ear during the event, among others.

### BRIEF DESCRIPTION OF THE DRAWINGS

The present disclosure is described with reference to the accompanying drawings. In the drawings, like reference numbers indicate identical or functionally similar elements. Additionally, the left most digit(s) of a reference number identifies the drawing in which the reference number first appears. In the accompanying drawings:

FIG. 1 illustrates a simplified block diagram of an exemplary real-world venue according to some exemplary embodiments of the present disclosure;

FIG. 2 graphically illustrates exemplary location identification within the exemplary real-world venue according to some exemplary embodiments of the present disclosure;

FIG. 3 graphically illustrates a virtual representation of the exemplary real-world venue that can be useful in determining the soundwaves that need to be emitted by real-world monitor speaker arrays within the exemplary real-world venue according to some exemplary embodiments of the present disclosure;

FIG. 4 graphically illustrates an exemplary operation of the exemplary real-world venue in accordance with some exemplary embodiments of the present disclosure;

FIG. 5 illustrates an exemplary operational control flow for the exemplary real-world venue in accordance with some exemplary embodiments of the present disclosure;

FIG. 6A and FIG. 6B graphically illustrate exemplary real-world speaker arrays that can be implemented within the exemplary real-world venue according to some exemplary embodiments of the present disclosure; and

FIG. 7 illustrates a simplified block diagram of an exemplary computer system that can be implemented within the exemplary real-world environment according to some exemplary embodiments of the present disclosure.

The present disclosure will now be described with reference to the accompanying drawings.

### DETAILED DESCRIPTION

The following disclosure provides many different embodiments, or examples, for implementing different features of the provided subject matter. Specific examples of components and arrangements are described herein to simplify the present disclosure. These are, of course, merely examples and are not intended to be limiting. Aspects of the present disclosure are best understood from the following detailed description when read with the accompanying figures. The present disclosure may repeat reference numerals and/or letters in the various examples. This repetition does not in itself dictate a relationship between the various embodiments and/or configurations discussed. It is noted that, in accordance with the standard practice in the industry, features are not drawn to scale. In fact, the dimensions of the features may be arbitrarily increased or reduced for clarity of discussion. The following disclosure may include the terms “about” or “substantially” to indicate the value of a given quantity can vary based on a particular technology. Based on the technology, the term “about” or “substantially” can indicate a value of a given quantity that varies within, for example, 1-15% of the value (e.g., ±1%, ±2%, ±5%, ±10%, or ±15% of the value).

### Overview

Systems, methods, and apparatuses can generate one or more monitor audio mixes that are associated with an event being hosted by a real-world venue. These systems, methods, and apparatuses can determine one or more locations of one or more real-world performers within the real-world venue. These systems, methods, and apparatuses can determine one or more parameters, characteristics, and/or attributes for one or more soundwaves that need to be emitted by one or more real-world monitor speaker arrays to provide the one or more monitor audio mixes to one or more locations. These systems, methods, and apparatuses can configure the one or more soundwaves in accordance with these parameters, characteristics, and/or attributes. These systems, methods, and apparatuses can provide these soundwaves having these parameters, characteristics, and/or attributes configured to the one or more monitor speaker arrays to generate the one or more monitor audio mixes to the one or more locations of one or more real-world performers within the real-world venue.

### Exemplary Real-World Venue

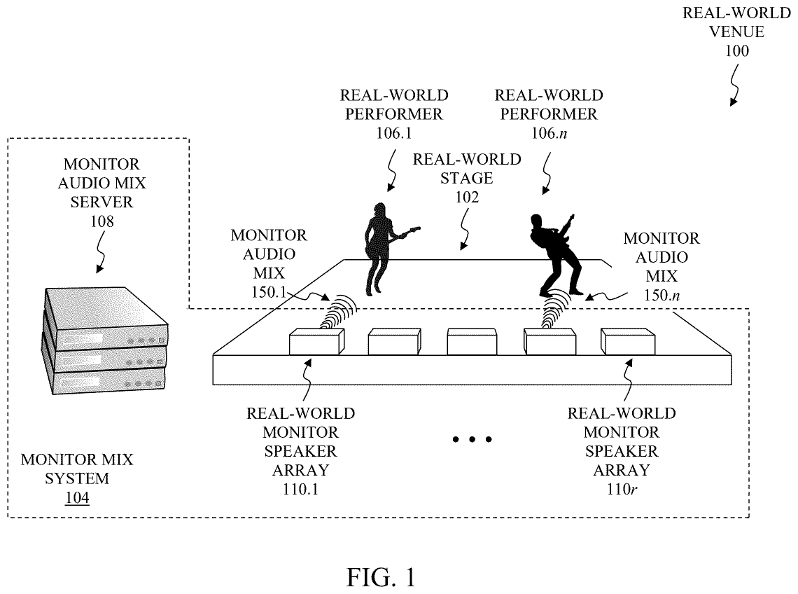

FIG. 1 illustrates a simplified block diagram of an exemplary real-world venue according to some exemplary embodiments of the present disclosure. In the exemplary embodiment illustrated in FIG. 1, the real-world venue 100 can generate one or more monitor audio mixes that are associated with an event being hosted by the real-world venue 100. For example, the real-world venue 100 can represent a music real-world venue, for example, a music theater, a music club, and/or a concert hall, a sporting real-world venue, for example, an arena, a convention center, and/or a stadium, and/or any other suitable real-world venue that will be apparent to those skilled in the relevant art(s) without departing the spirit and scope of the present disclosure. And as another example, the event can represent a musical event, a theatrical event, a sporting event, a motion picture, and/or any other suitable event that will be apparent to those skilled in the relevant art(s) without departing the spirit and scope of the present disclosure. As illustrated in FIG. 1, the real-world venue 100 can provide the one or more monitor audio mixes to one or more real-world performers that are associated with the event to allow these real-world performers to deliver a cohesive and accurate performance of the event. As to be described herein, the real-world venue 100 can track one or more locations of the one or more real-world performers within the real-world venue 100. In some embodiments, the real-world venue 100 can dynamically steer the one or more monitor audio mixes to advantageously follow and/or track these real-world performers as these real-world performers are performing the event. This tracking and/or following of the one or more real-world performers beneficially allows these real-world performers to hear customized and/or balanced audio streams that are associated with the event to enhance their performance of the event. In the exemplary embodiment illustrated in FIG. 1, the real-world venue 100 can include a real-world stage 102 and a monitor mix system 104.

The real-world stage 102 can be utilized by one or more real-world performers 106.1 through 106.n to perform the event. However, those skilled in the relevant art(s) will recognize that the teachings herein are applicable to other real-world venues that may, or may not, include the real-world stage 102 without departing from the spirit and scope of the present disclosure. Although the real-world stage 102 is illustrated as including the one or more real-world performers 106.1 through 106.n in FIG. 1, those skilled in the relevant art(s) will recognize that the teachings herein are applicable to any suitable number of one or more real-world performers, often dependent on the event, without departing from the spirit and scope of the present disclosure. In some embodiments, the real-world stage 102 can represent a concert stage, a performance stage, a festival stage, an outdoor stage, a proscenium stage, a thrust stage, an arena stage, and/or a black box theater, among others.

The monitor mix system 104 provides one or more monitor audio mixes 150.1 through 150.n to the one or more real-world performers 106.1 through 106.n as these real-world performers are performing the event. As described herein, the monitor mix system 104 provides a corresponding monitor audio mix from among the one or more monitor audio mixes 150.1 through 150.n to one or more corresponding real-world performers from among the one or more real-world performers 106.1 through 106.n. In some embodiments, the corresponding monitor audio mix beneficially allows the one or more corresponding real-world performers to hear themselves as well as other elements of the performance as needed. In these embodiments, the corresponding monitor audio mix can include vocals, instruments, backing tracks, click tracks, and/or other vocals and instruments, among others. As illustrated in FIG. 1, the monitor mix system 104 can include a monitor audio mix server 108 and one or more real-world monitor speaker arrays 110.1 through 110.r.

In the exemplary embodiment illustrated in FIG. 1, the monitor audio mix server 108 can configure the one or more real-world monitor speaker arrays 110.1 through 110.r to provide the one or more monitor audio mixes 150.1 through 150.n. In some embodiments, the monitor audio mix server 108 can configure the one or more real-world monitor speaker arrays 110.1 through 110.r to provide the corresponding monitor audio mix from among the one or more monitor audio mixes 150.1 through 150.n to the one or more corresponding real-world performers from among the one or more real-world performers 106.1 through 106.n. In these embodiments, the monitor audio mix server 108 can cause the one or more real-world monitor speaker arrays 110.1 through 110.r to dynamically steer the corresponding monitor audio mix to follow and/or track the one or more corresponding real-world performers as these real-world performers are performing the event. As part of the tracking and/or the following, the monitor audio mix server 108 can identify the one or more real-world performers 106.1 through 106.n within the real-world venue 100. In some embodiments, the monitor audio mix server 108 can thereafter determine one or more locations of the one or more real-world performers 106.1 through 106.n within the real-world venue 100, for example, on the real-world stage 102. In these embodiments, the monitor audio mix server 108 can beneficially follow and/or track the one or more locations of the one or more real-world performers 106.1 through 106.n, for example, in real-time, or near real-time, as these real-world performers are performing the event. After identifying the one or more locations of the one or more real-world performers 106.1 through 106.n, the monitor audio mix server 108 can configure the one or more real-world monitor speaker arrays 110.1 through 110.r to provide the one or more monitor audio mixes 150.1 through 150.n to the one or more real-world performers 106.1 through 106.n. As part of this configuring, the monitor audio mix server 108 can assign the corresponding monitor audio mix from among the one or more monitor audio mixes 150.1 through 150.n to the one or more corresponding real-world performers from among the one or more real-world performers 106.1 through 106.n. After assigning the corresponding monitor audio mix, the monitor audio mix server 108 can configure the one or more real-world monitor speaker arrays 110.1 through 110.r to provide the corresponding monitor audio mix to the one or more corresponding real-world performers.

In some embodiments, the monitor audio mix server 108 and the one or more real-world monitor speaker arrays 110.1 through 110.r can functionally cooperate to provide a wave field synthesis (WFS) spatial audio rendering. As part of the WFS spatial audio rendering, the monitor audio mix server 108 determines one or more locations of one or more virtual sources that correspond to the one or more real-world performers 106.1 through 106.n in a virtual environment that is associated with the real-world venue 100. In some embodiments, these virtual sources can include vocals, instruments, backing tracks, click tracks, and/or other vocals and instruments, among others. As part of this WFS spatial audio rendering, the monitor audio mix server 108 determines one or more wavefronts that would be generated by these virtual sources in the virtual environment. As part of this WFS spatial audio rendering, the monitor audio mix server 108 determines soundwaves that need to be emitted by the one or more real-world monitor speaker arrays 110.1 through 110.r to create these wavefronts within the real-world venue 100. In some embodiments, the monitor audio mix server 108 can determine one or more parameters, characteristics, and/or attributes for the soundwaves that need to be emitted by the one or more real-world monitor speaker arrays 110.1 through 110. r. For example, the monitor audio mix server 108 can determine one or more phases and/or amplitudes for the soundwaves that need to be emitted by the one or more real-world monitor speaker arrays 110.1 through 110.r. In these embodiments, the monitor audio mix server 108 can provide these soundwaves having these parameters, characteristics, and/or attributes to the one or more real-world monitor speaker arrays 110.1 through 110.r. In these embodiments, these soundwaves can include vocals, instruments, backing tracks, click tracks, and/or other vocals and instruments, among others, to be heard by the one or more real-world performers 106.1 through 106.n during the event.

The one or more real-world monitor speaker arrays 108.1 through 108.r can provide the one or more monitor audio mixes 150.1 through 150.n to the one or more real-world performers 106.1 through 106.n as described herein. Generally, the number of real-world monitor speaker arrays from among the one or more real-world monitor speaker arrays 108.1 through 108.r can dependent upon, for example, array geometry, number of loudspeakers per array, listening area size, for example, size of the real-world stage 102, and/or placement and distance, among others. In some embodiments, each real-world monitor speaker array from among the one or more real-world monitor speaker arrays 108.1 through 108.r can be characterized as having a horizontal field of view (FOV) between approximately sixty (60) and approximately one hundred twenty (180) degrees and/or a vertical FOV between approximately thirty (30) and approximately sixty (60) degrees. In these embodiments, a single real-world monitor speaker array 108.1 having a horizontal FOV of approximately ninety (90) degrees can be sufficient to cover the real-world stage 102 within a small theater; however, more real-world monitor speaker arrays 108.1 through 108.r are needed to sufficiently cover the real-world stage 102 within a concert hall or a large theater. In some embodiments, the one or more real-world monitor speaker arrays 108.1 through 108.r emit the soundwaves received from the monitor audio mix server 108 to provide the one or more monitor audio mixes 150.1 through 150.n to the one or more real-world performers 106.1 through 106.n as described herein. In these embodiments, the soundwaves emitted by the one or more real-world monitor speaker arrays 110.1 through 110.r constructively and/or destructively interfere with one another within the real-world venue 100 to generate the one or more monitor audio mixes 150.1 through 150.n. In some embodiments, the one or more real-world monitor speaker arrays 108.1 through 108.r can include multiple loudspeakers that are arranged in various geometries, such as linear, circular, and/or rectangular patterns, among others. In these embodiments, these loudspeakers can include one or more super tweeters, one or more tweeters, one or more mid-range speakers, one or more woofers, one or more subwoofers, and/or one or more full-range speakers to provide some examples.

### Exemplary Location Identification Within the Exemplary Real-World Venue

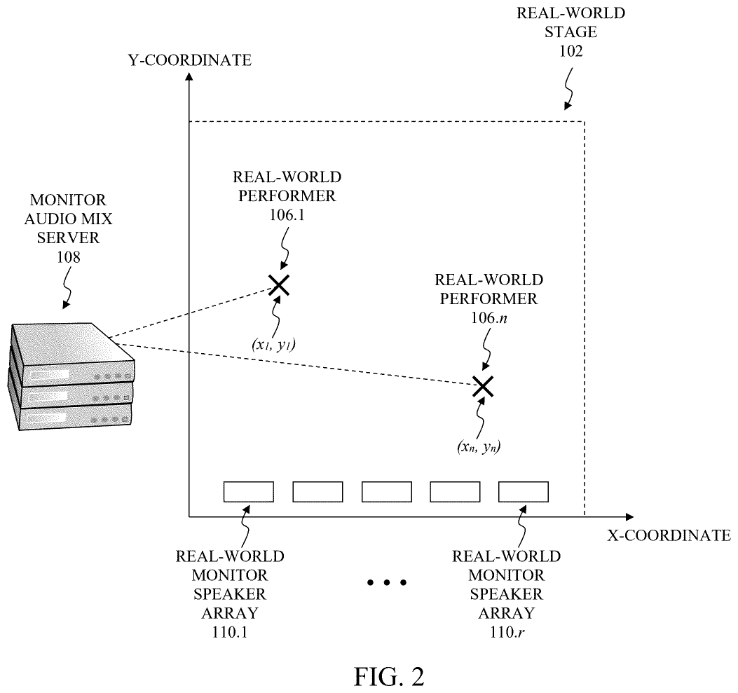

FIG. 2 graphically illustrates exemplary location identification within the exemplary real-world venue according to some exemplary embodiments of the present disclosure. As described herein, the monitor audio mix server 108 can determine one or more locations of the one or more real-world performers 106.1 through 106.n within the real-world venue 100, for example, on the real-world stage 102. In some embodiments, the monitor audio mix server 108 can determine two-dimensional coordinates, or three-dimensional coordinates, of the one or more real-world performers 106.1 through 106.n within the real-world venue 100. As illustrated in FIG. 2, the monitor audio mix server 108 can determine a first two-dimensional coordinate (x₁, y₁) within a Cartesian coordinate system for a first real-world performer 106.1 from among the one or more real-world performers 106.1 through 106.n and an n^{th} two-dimensional coordinate (xₙ, yₙ) within the Cartesian coordinate system for a n^{th} real-world performer 106.n from among the one or more real-world performers 106.1 through 106.n. In these embodiments, the monitor audio mix server 108 can utilize, for example, infrared (IR) tracking, radio frequency (RF) tracking, ultrasonic tracking, camera-based tracking, Wi-Fi tracking, Bluetooth tracking, and/or pressure sensors, among others, to determine the two-dimensional coordinates, or the three-dimensional coordinates, of the one or more real-world performers 106.1 through 106.n.

### Exemplary Phase and/or Amplitude Determination Within the Exemplary Real-World Venue

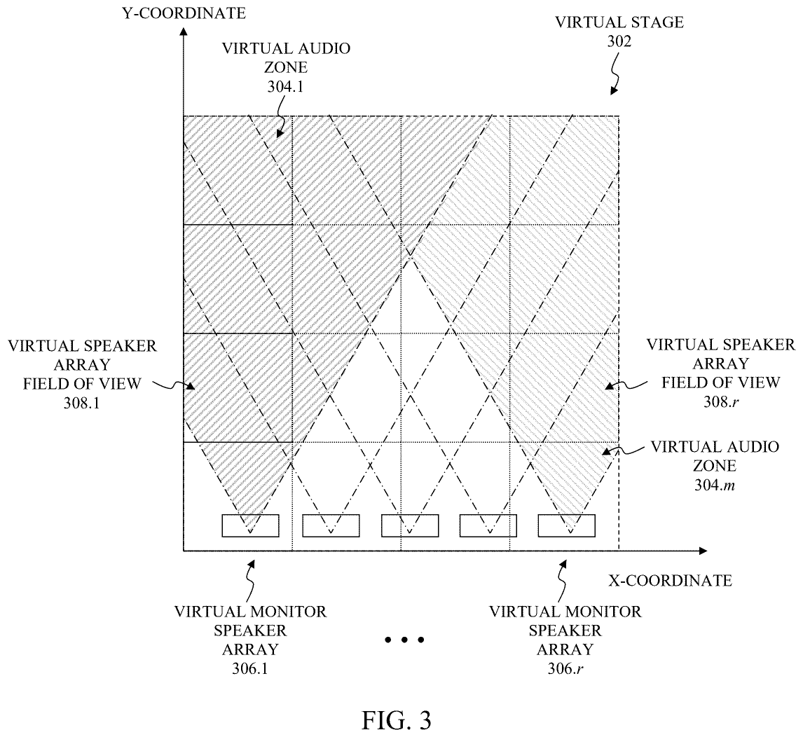

FIG. 3 graphically illustrates a virtual representation of the exemplary real-world venue that can be useful in determining the soundwaves that need to be emitted by real-world monitor speaker arrays within the exemplary real-world venue according to some exemplary embodiments of the present disclosure. In the exemplary embodiment illustrated in FIG. 3, the monitor audio mix server 108 determines the phases and/or the amplitude for soundwaves that need to be emitted by the one or more real-world monitor speaker arrays 110.1 through 110.r to create the one or more monitor audio mixes 150.1 through 150.n based upon the one or more locations of the one or more real-world performers 106.1 through 106.n. In some embodiments, the phases and/or the amplitudes of the soundwaves that need to be emitted by the one or more real-world monitor speaker arrays 110.1 through 110.r to create the one or more monitor audio mixes 150.1 through 150.n can be determined in a virtual environment. In these embodiments, these phases and/or these amplitudes can be determined offline, namely, before the event is to begin. In some embodiments, these phases and/or these amplitudes can be stored as an organized collection of data to advantageous provide for their rapid retrieval during the performance of the event that beneficially reduces processing time, reduces computational load, provides consistent and predictable access times, and/or maintains low-latency performance as compared to real-time, or near-real time, calculations of these phases and/or these amplitudes.

As illustrated in FIG. 3, the monitor audio mix server 108 can logically segment a virtual stage 302 corresponding to a virtual representation of the real-world stage 102 into one or more virtual audio zones 304.1 through 304.m. In some embodiments, the monitor audio mix server 108 can logically segment the virtual stage 302 into a series of rows of virtual audio zones and a series of columns of virtual audio zones to form an array of virtual audio zones 304.1 through 304.m. After segmenting the virtual stage 302, the monitor audio mix server 108 determines one or more corresponding virtual monitor speaker arrays from among the one or more virtual monitor speaker arrays 306.1 through 306.r that provide coverage to each virtual audio zone from among the one or more virtual audio zones 304.1 through 304.m. As illustrated in FIG. 3, the one or more virtual monitor speaker arrays 306.1 through 306.r can provide consistent sound pressure levels within corresponding virtual speaker array field of views from among one or more virtual speaker array field of views 308.1 through 308.r. In some embodiments, each virtual monitor speaker array from among the one or more virtual monitor speaker arrays 306.1 through 306.r can be characterized as having a similar horizontal field of view (FOV) and/or vertical field of view (FOV) as its corresponding real-world monitor speaker array from among the one or more real-world monitor speaker arrays 108.1 through 108.r. In these embodiments, each virtual speaker array field of view from among the one or more virtual speaker array field of views 308.1 through 308.r can be characterized as including a horizontal field of view (FOV) between approximately sixty (60) and approximately one hundred twenty (180) degrees and/or a vertical FOV between approximately thirty (30) and approximately sixty (60) degrees.

The monitor audio mix server 108 identifies one or more virtual monitor speaker arrays from among the one or more virtual monitor speaker arrays 306.1 through 306.r to provide coverage to each virtual audio zone from among the one or more virtual audio zones 304.1 through 304.m based upon the one or more virtual speaker array field of views 308.1 through 308.r. In some embodiments, the monitor audio mix server 108 identifies one or more corresponding virtual speaker array field of views from among the virtual speaker array field of views 308.1 through 308.r that provide coverage to each virtual audio zone from among the one or more virtual audio zones 304.1 through 304.m. In these embodiments, the monitor audio mix server 108 can logically assign one or more virtual monitor speaker arrays from among the one or more virtual monitor speaker arrays 306.1 through 306.r that correspond to the one or more corresponding virtual speaker array field of views for each virtual audio zone from among the one or more virtual audio zones 304.1 through 304.m. For example, virtual monitor speaker arrays 306.1 through 306.(r −1) can be assigned to provide coverage to virtual audio zone 304.1 and virtual monitor speaker arrays 306.(r−1) through 306.r can be assigned to provide coverage to virtual audio zone 304.m.

After identifying one or more virtual monitor speaker arrays to cover each virtual audio zone, the monitor audio mix server 108 can simulate the propagation of the soundwaves through these virtual monitor speaker arrays to determine the phases and/or the amplitudes for these soundwaves to cover each virtual audio zone as described herein. In some embodiments, the monitor audio mix server 108 can perform one or more simulations, such as a finite difference time domain (FDTD) simulation, a finite element method (FEM) simulation, a ray tracing simulation, and/or an image method simulation, among others, to determine the phases and/or the amplitudes of the soundwaves that need to be emitted by one or more virtual monitor speaker arrays from among the one or more virtual monitor speaker arrays 306.1 through 306. to cover each virtual audio zone from among the one or more virtual audio zones 304.1 through 304.m. Generally, these simulations use various mathematical models and computational techniques to mimic how these soundwaves propagate through and interact with the virtual stage 302. These mathematical models and computational techniques effectively discretize the virtual stage 302 into a grid or mesh, solve various wave equations, for example, one-dimensional wave equations, two-dimensional wave equations, three-dimensional wave equations, Hemholtz equations, Klein-Gordon equations, Schrodinger equations, and/or Maxwell's equations, among others, iteratively over time, and update sound pressure and/or particle velocity fields according to the wave equations to determine the phases and/or the amplitudes of the soundwaves that need to be emitted by one or more virtual monitor speaker arrays from among the one or more virtual monitor speaker arrays 306.1 through 306.r to cover each virtual audio zone from among the one or more virtual audio zones 304.1 through 304.m. In some embodiments, these simulations can consider one or more acoustical properties of the virtual stage 302, such as frequency response, impedance, sensitivity, power handling, directivity, distortion, enclosure type, crossover frequency response, and/or acoustic suspension and porting, among others, and/or one or more acoustical properties of the virtual stage 302, such as speed, absorption, reflection, reverberation, transmission loss, diffraction, frequency response, impedance, resonance, and/or diffusion, among others, to provide some examples. After determining these phases and/or the amplitudes, the monitor audio mix server 108 can store for each virtual audio zone from among the one or more virtual audio zones 304.1 through 304.m its assigned virtual monitor speaker arrays from among the one or more virtual monitor speaker arrays 306.1 through 306.r along with their corresponding phases and/or their corresponding amplitudes as the organized collection of data, often referred to as a database. In these embodiments, the database may include one or more data tables having data values, such as alphanumeric strings, integers, decimals, floating points, dates, times, binary values, Boolean values, and/or enumerations to provide some examples.

### Exemplary Operations of the Exemplary Real-World Venue

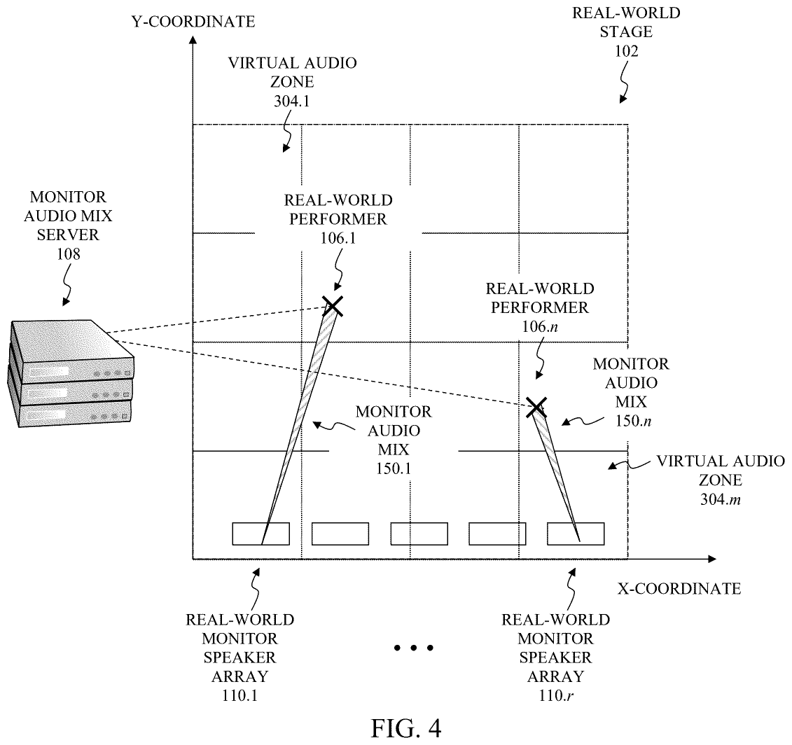

FIG. 4 graphically illustrates an exemplary operation of the exemplary real-world venue in accordance with some exemplary embodiments of the present disclosure. In the exemplary embodiment illustrated in FIG. 4, the monitor audio mix server 108 can determine one or more locations of the one or more real-world performers 106.1 through 106.n within the real-world venue 100, for example, on the real-world stage 102 as described herein. In some embodiments, the monitor audio mix server 108 can beneficially follow and/or track the one or more locations of the one or more real-world performers 106.1 through 106.n. In these embodiments, the monitor audio mix server 108 can follow and/or track the one or more locations in real-time, or near real-time, as these real-world performers are performing the event. For example, the monitor audio mix server 108 can follow and/or track the two-dimensional coordinates, or the three-dimensional coordinates, of the one or more real-world performers 106.1 through 106.n within the real-world venue 100 in real-time, or near real-time, as these real-world performers are performing the event. In some embodiments, the monitor audio mix server 108 can dynamically adjust, adapt, update, or refresh the one or more locations of the one or more real-world performers 106.1 through 106.n as the one or more real-world performers 106.1 through 106.n are performing the event. In these embodiments, the monitor audio mix server 108 can dynamically adjust, adapt, update, or refresh the one or more locations of the one or more real-world performers 106.1 through 106.n continuously over time; at discrete intervals in time; for example, once every second, once every couple of seconds, once every minute, once every couple of minutes, among others, as the one or more real-world performers 106.1 through 106.n are performing the event; and/or in response to an event, such as the beginning of the performance of the event. In some embodiments, this dynamically adjusting, adapting, updating, or refreshing of the one or more locations of the one or more real-world performers 106.1 through 106.n allows the monitor audio mix server 108 to dynamically steer the one or more monitor audio mixes 150.1 through 150.n to advantageously follow the one or more real-world performers 106.1 through 106.n as these real-world performers are performing the event.

After determining the one or more locations of the one or more real-world performers 106.1 through 106.n, the monitor audio mix server 108 can identify a corresponding virtual audio zone from among the one or more virtual audio zones 304.1 through 304.m that corresponds to each location from among the one or more locations of the one or more real-world performers 106.1 through 106.n. In some embodiments, the monitor audio mix server 108 compares the two-dimensional coordinates, or the three-dimensional coordinates, of the one or more locations of the one or more real-world performers 106.1 through 106.n with the two-dimensional coordinates, or the three-dimensional coordinates, of the one or more virtual audio zones 304.1 through 304.m identify the corresponding virtual audio zone that corresponds to each location from among the one or more locations.

After identifying the corresponding virtual audio zone that corresponds to each location from among the one or more locations, the monitor audio mix server 108 determines the phases and/or the amplitudes of the soundwaves that need to be emitted by the one or more real-world monitor speaker arrays 110.1 through 110.r to provide a corresponding monitor audio mix from among the one or more monitor audio mixes 150.1 through 150.n to each location from among the one or more locations. In some embodiments, the monitor audio mix server 108 can access the database indicating the one or more corresponding real-world monitor speaker arrays from among the one or more real-world monitor speaker arrays 110.1 through 110.r that corresponds to each virtual audio zone from among the one or more virtual audio zones 304.1 through 304.m and the phases and/or the amplitudes of the soundwaves that need to be emitted by the one or more corresponding real-world monitor speaker arrays to provide the corresponding monitor audio mix to each location from among the one or more locations. In these embodiments, the monitor audio mix server 108 can query the database with the corresponding virtual audio zone that corresponds to each location from among the one or more locations to return the one or more corresponding real-world monitor speaker arrays that correspond to the corresponding virtual audio zone that corresponds to each location from among the one or more locations and the phases and/or the amplitudes of the soundwaves that need to be emitted by the one or more corresponding real-world monitor speaker arrays to provide the corresponding monitor audio mix to the corresponding virtual audio zone that corresponds to each location from among the one or more locations.

After determining the phases and/or the amplitudes of the soundwaves that need to be emitted by the one or more real-world monitor speaker arrays 110.1 through 110.r, the monitor audio mix server 108 configures the phases and/or the amplitudes of the soundwaves that need to be emitted by the one or more corresponding real-world monitor speaker arrays to provide the corresponding monitor audio mix to each location from among the one or more locations. some embodiments, the soundwaves can include vocals, instruments, backing tracks, click tracks, and/or other vocals and instruments, among others, to be emitted by the one or more real-world monitor speaker arrays 110.1 through 110.r to provide a corresponding monitor audio mix from among the one or more monitor audio mixes 150.1 through 150.n to each location from among the one or more locations. In some embodiments, the monitor audio mix server 108 provides these soundwaves having their phases and/or amplitudes configured to the one or more corresponding real-world monitor speaker arrays for playback to provide the corresponding monitor audio mix to each location from among the one or more locations.

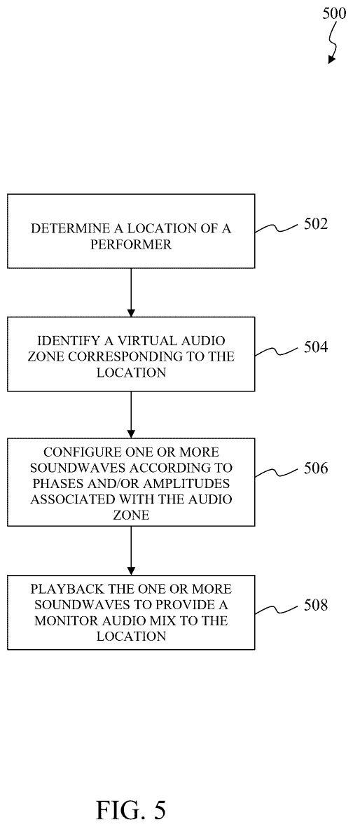

FIG. 5 illustrates an exemplary operational control flow for the exemplary real-world venue in accordance with some exemplary embodiments of the present disclosure. The following discussion is to describe an exemplary operational control flow 500. The present disclosure is not limited to these exemplary operational control flows. The operational control flow 500 can provide a monitor audio mix, such as one of the one or more monitor audio mixes 150.1 through 150.n to provide an example, to a real-world performer, such as one of the one or more real-world performers 106.1 through 106.n to provide an example, that is associated with the event to allow this real-world performer to deliver a cohesive and accurate performance of the event. As to be described herein, the operational control flow 500 can track a location of the performer within a real-world venue, such as the real-world venue 100 to provide an example. In some embodiments, the operational control flow 500 can dynamically steer the monitor audio mix to advantageously follow and/or track this real-world performer as this real-world performer is performing the event. This tracking and/or following of the real-world performer beneficially allows this real-world performer to hear customized and/or balanced audio streams that are associated with the event to enhance his/her performance of the event. In some embodiments, the operational control flow 500 can be performed by the monitor mix system 104.

At operation 502, the operational control flow 500 determines the location of the performer. In some embodiments, the operational control flow 500 can determine two-dimensional coordinates, or three-dimensional coordinates, of the performer within a real-world venue, such as the real-world venue 100 to provide an example, as described herein.

At operation 504, the operational control flow 500 identifies a virtual audio zone corresponding to the location. In some embodiments, the operational control flow 500 can logically segment the real-world venue into one or more virtual audio zones. In these embodiments, the operational control flow 500 can identify the virtual audio zone from among the one or more virtual audio zones that includes the location as described herein.

At operation 506, the operational control flow 500 configures one or more soundwaves according to phases and/or amplitudes that are associated with the virtual audio zone from operation 504. In some embodiments, the operational control flow 500 can access the database that indicates one or more real-world monitor speaker arrays, such as one or more of the one or more real-world monitor speaker arrays 110.1 through 110.r to provide an example, that are assigned to the virtual audio zone from operation 504 and the phases and/or the amplitudes of the soundwaves that need to be emitted by these real-world monitor speaker arrays to provide the monitor audio mix to the location. In these embodiments, the operational control flow 500 can query the database with the virtual audio zone from operation 504 to return the phases and/or the amplitudes of the soundwaves as described herein At operation 508, the operational control flow 500 plays back the one or more soundwaves from operation 506 to provide a monitor audio mix to the location. The operational control flow 500 provides the one or more soundwaves from operation 506 to the one or more real-world monitor speaker arrays from operation 506 for playback to create the monitor audio mix to the location as described herein. In some embodiments, the operational control flow 500 can repeat operation 502 through operation 508 continuously over time; at discrete intervals in time; for example, once every second, once every couple of seconds, once every minute, once every couple of minutes, among others, as the one or more real-world performers 106.1 through 106.n are performing the event; and/or in response to an event, such as the beginning of the performance of the event. In these embodiments, the operational control flow 500 can repeat these operations for the duration of an event being hosted by the real-world venue.

### Exemplary Real-World Monitor Speaker Arrays That can be Implemented Within the Exemplary Real-World Environment

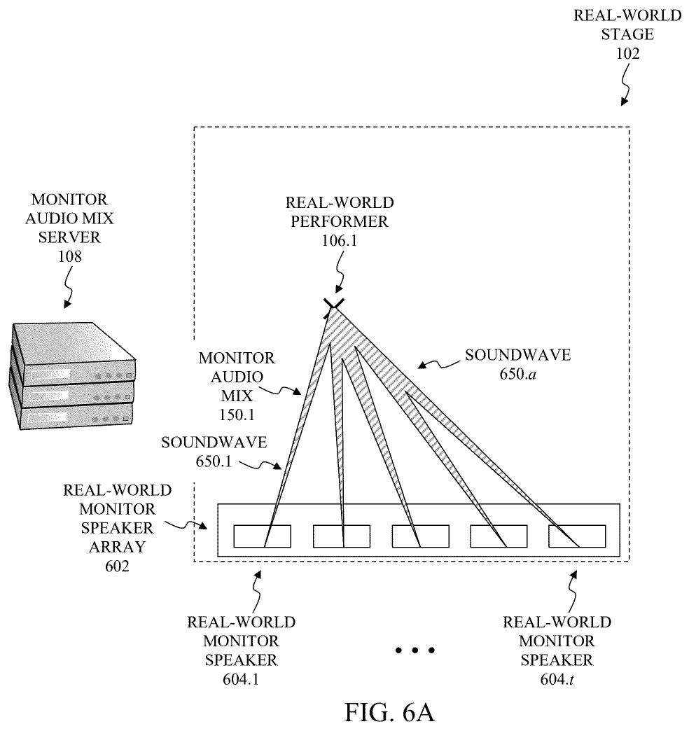

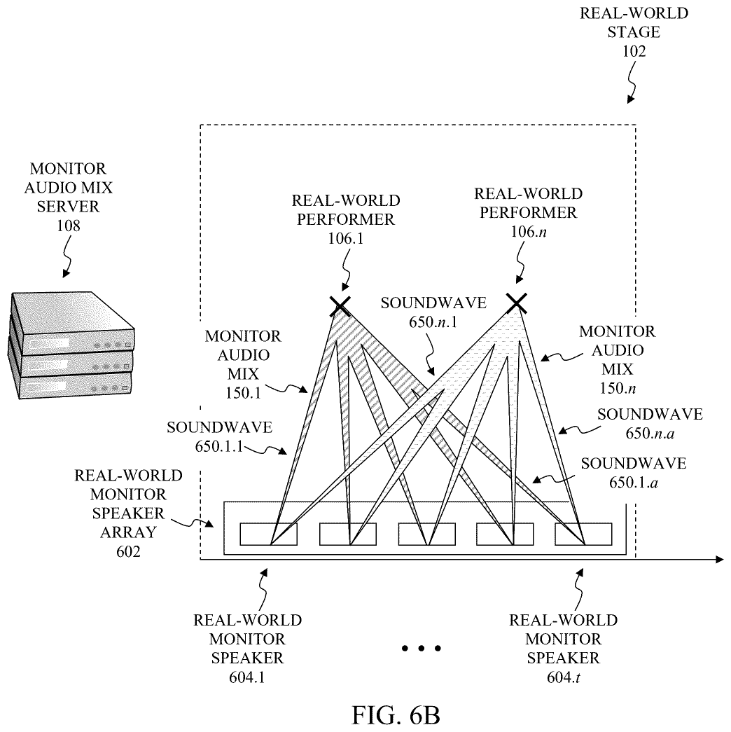

FIG. 6A and FIG. 6B graphically illustrate exemplary real-world speaker arrays that can be implemented within the exemplary real-world venue according to some exemplary embodiments of the present disclosure. As described herein, the monitor audio mix server 108 can configure the one or more real-world monitor speaker arrays 110.1 through 110.r to provide the one or more monitor audio mixes 150.1 through 150.n. In some embodiments, the monitor audio mix server 108 can configure the one or more real-world monitor speaker arrays 110.1 through 110.r to provide the corresponding monitor audio mix from among the one or more monitor audio mixes 150.1 through 150.n to the one or more corresponding real-world performers from among the one or more real-world performers 106.1 through 106.n. The discussion of FIG. 6A and FIG. 6B to follow is to describe exemplary operations of a real-world monitor speaker array 602 from among the real-world monitor speaker arrays 110.1 through 110.r. The discussion of FIG. 6A to follow is to describe an exemplary operation of the real-world monitor speaker array 602 providing the monitor audio mix 150.1 to the real-world performer 106.1. And the discussion of FIG. 6B to follow is to describe an exemplary operation of the real-world monitor speaker array 602 providing the monitor audio mixes 150.1 through 150.n to the one or more real-world performers 106.1 through 106.n.

In the exemplary embodiment illustrated in FIG. 6A and FIG. 6B, the monitor audio mix server 108 and the real-world monitor speaker array 602 can functionally cooperate to provide a wave field synthesis (WFS) spatial audio rendering. As illustrated in FIG. 6A and as part of the WFS spatial audio rendering, the monitor audio mix server 108 determines a location of a virtual source that corresponds to the real-world performer 106.1 in a virtual environment in a substantially similar manner as described herein. As part of this WFS spatial audio rendering, the monitor audio mix server 108 determines one or more wavefronts that would be generated by this virtual source in the virtual environment. As part of this WFS spatial audio rendering, the monitor audio mix server 108 determines soundwaves 650.1 through 650.a that need to be emitted by the real-world monitor speaker array 602 to create these wavefronts to generate the monitor audio mix 150.1. In some embodiments, the monitor audio mix server 108 can determine one or more parameters, characteristics, and/or attributes for the soundwaves 650.1 through 650.a that need to be emitted by the real-world monitor speaker array 602. For example, the monitor audio mix server 108 can determine one or more phases and/or amplitudes for the soundwaves 650.1 through 650.a that need to be emitted by the real-world monitor speaker array 602. In these embodiments, the monitor audio mix server 108 can provide the soundwaves 650.1 through 650.a having these parameters, characteristics, and/or attributes to the real-world monitor speaker array 602.

As illustrated in FIG. 6A, the real-world monitor speaker array 602 can include real-world monitor speakers 604.1 through 604.t that are arranged in various geometries, such as linear, circular, and/or rectangular patterns, among others. In these embodiments, the real-world monitor speakers 604.1 through 604.t loudspeakers can include one or more super tweeters, one or more tweeters, one or more mid-range speakers, one or more woofers, one or more subwoofers, and/or one or more full-range speakers to provide some examples. In some embodiments, the monitor audio mix server 108 determines soundwaves 650.1 through 650.a that need to be emitted by real-world monitor speakers 604.1 through 604.t within the real-world monitor speaker array 602 to create these wavefronts. In these embodiments, the real-world monitor speakers 604.1 through 604.t emit corresponding soundwaves from among the soundwaves 650.1 through 650.a to provide the monitor audio mix 150.1 through 150.n to the real-world performer 106.1 as described herein. In these embodiments, the soundwaves 650.1 through 650.a emitted by the real-world monitor speakers 604.1 through 604.t constructively and/or destructively interfere with one another to generate the monitor audio mix 150.1.

As illustrated in FIG. 6B and as part of the WFS spatial audio rendering, the monitor audio mix server 108 determines a location of virtual sources that corresponds to the real-world performers 106.1 through 106.n in a virtual environment in a substantially similar manner as described herein. As part of this WFS spatial audio rendering, the monitor audio mix server 108 determines one or more wavefronts that would be generated by these virtual sources in the virtual environment. As part of this WFS spatial audio rendering, the monitor audio mix server 108 determines soundwaves 650.1.1 through 650.n.a that need to be emitted by the real-world monitor speaker array 602 to create these wavefronts. In some embodiments, the monitor audio mix server 108 can determine one or more parameters, characteristics, and/or attributes for the soundwaves 650.1.1 through 650.n.a that need to be emitted by the real-world monitor speaker array 602. For example, the monitor audio mix server 108 can determine one or more phases and/or amplitudes for the soundwaves 650.1.1 through 650.n.a that need to be emitted by the real-world monitor speaker array 602. In these embodiments, the monitor audio mix server 108 can provide the soundwaves 650.1.1 through 650.n.a having these parameters, characteristics, and/or attributes to the real-world monitor speaker array 602.

As illustrated in FIG. 6B, the real-world monitor speaker array 602 can include the real-world monitor speakers 604.1 through 604.t that are arranged in various geometries, such as linear, circular, and/or rectangular patterns, among others. In some embodiments, the monitor audio mix server 108 determines soundwaves 650.1.1 through 650.n. a that need to be emitted by real-world monitor speakers 604.1 through 604.t within the real-world monitor speaker array 602 to create these wavefronts to generate the monitor audio mixes 150.1 through 150.n. In these embodiments, the monitor audio mix server 108 determines soundwaves 650.1.1 through 650.1.a that need to be emitted by real-world monitor speakers 604.1 through 604.t within the real-world monitor speaker array 602 to create wavefronts to generate the monitor audio mix 150.1 and soundwaves 650.n.1 through 650.n.a that need to be emitted by real-world monitor speakers 604.1 through 604.t within the real-world monitor speaker to generate the monitor audio mix 150.n. In these embodiments, the real-world monitor speakers 604.1 through 604.t emit corresponding soundwaves from among the soundwaves 650.1.1 through 650.1.a to provide the monitor audio mixes 150.1 through 150.n to the real-world performers 106.1 through 106.n as described herein. In these embodiments, the soundwaves 650.1.1 through 650.1.a emitted by the real-world monitor speakers 604.1 through 604.t constructively and/or destructively interfere with one another to generate the monitor audio mix 150.1 and the soundwaves 650.n.1 through 650.n.a emitted by the real-world monitor speakers 604.1 through 604.t constructively and/or destructively interfere with one another to generate the monitor audio mix 150.n.

### Exemplary Computer System That can be Implemented Within the Exemplary Real-World Environment

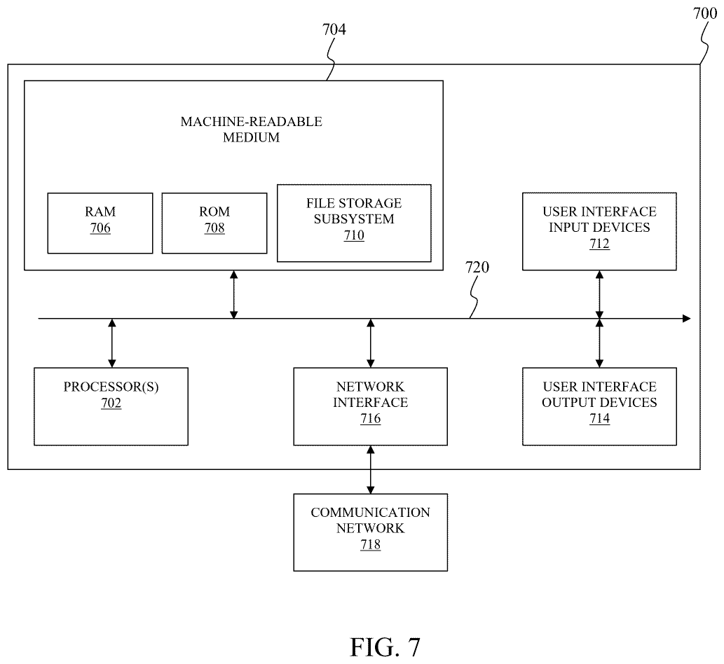

FIG. 7 illustrates a simplified block diagram of an exemplary computer system that can be implemented within the exemplary real-world environment according to some exemplary embodiments of the present disclosure. The discussion of FIG. 7 to follow is to describe a computer system 700 that can be used to implement the monitor mix system 104 and/or the monitor audio mix server 108, among others, as described herein.

In the exemplary embodiment illustrated in FIG. 7, the computer system 700 includes one or more processors 702. In some embodiments, the one or more processors 702 can include, or can be, any of a microprocessor, graphics processing unit, or digital signal processor, and their electronic processing equivalents, such as an Application Specific Integrated Circuit (“ASIC”) or Field Programmable Gate Array (“FPGA”). As used herein, the term “processor” signifies a tangible data and information processing device that physically transforms data and information, typically using a sequence transformation (also referred to as “operations”). Data and information can be physically represented by an electrical, magnetic, optical, or acoustical signal that is capable of being stored, accessed, transferred, combined, compared, or otherwise manipulated by the processor. The term “processor” can signify a singular processor and multi-core systems or multi-processor arrays, including graphic processing units, digital signal processors, digital processors, or combinations of these elements. The processor can be electronic, for example, comprising digital logic circuitry (for example, binary logic), or analog (for example, an operational amplifier). The processor may also operate to support performance of the relevant operations in a “cloud computing” environment or as a “software as a service” (SaaS). For example, at least some of the operations may be performed by a group of processors available at a distributed or remote system, these processors accessible via a communications network (e.g., the Internet) and via one or more software interfaces (e.g., an application program interface (API).) In some embodiments, the computer system 700 can include an operating system, such as Microsoft's Windows, Sun Microsystems's Solaris, Apple Computer's MacOs, Linux or UNIX. In some embodiments, the computer system 700 can also include a Basic Input/Output System (BIOS) and processor firmware. The operating system, BIOS and firmware are used by the one or more processors 702 to control subsystems and interfaces coupled to the one or more processors 702. In some embodiments, the one or more processors 702 can include the Pentium and Itanium from Intel, the Opteron and Athlon from Advanced Micro Devices, and the ARM processor from ARM Holdings.

As illustrated in FIG. 7, the computer system 700 can include a machine-readable medium 704. In some embodiments, the machine-readable medium 704 can further include a main random-access memory (“RAM”) 706, a read only memory (“ROM”) 708, and/or a file storage subsystem 710. The RAM 706 can store instructions and data during program execution and the ROM 708 can store fixed instructions. The file storage subsystem 710 provides persistent storage for program and data files, and may include a hard disk drive, a floppy disk drive along with associated removable media, a CD-ROM drive, an optical drive, a flash memory, or a removable media cartridge.

The computer system 700 can further include user interface input devices 712 and user interface output devices 714. The user interface input devices 712 can include an alphanumeric keyboard, a keypad, pointing devices such as a mouse, trackball, touchpad, stylus, or graphics tablet, a scanner, a touchscreen incorporated into the display, audio input devices such as voice recognition systems or microphones, eye-gaze recognition, brainwave pattern recognition, and other types of input devices to provide some examples. The user interface input devices 712 can be connected by wire or wirelessly to the computer system 700. Generally, the user interface input devices 712 are intended to include all possible types of devices and ways to input information into the computer system 700. The user interface input devices 712 typically allow a user to identify objects, icons, text, and the like that appear on some types of user interface output devices, for example, a display subsystem. The user interface output devices 714 may include a display subsystem, a printer, a fax machine, or non-visual displays such as audio output devices. The display subsystem may include a cathode ray tube (CRT), a flat-panel device such as a liquid crystal display (LCD), a projection device, or some other device for creating a visible image such as a virtual reality system. The display subsystem may also provide non-visual display such as via audio output or tactile output (e.g., vibrations) devices. Generally, the user interface output devices 714 are intended to include all possible types of devices and ways to output information from the computer system 700.

The computer system 700 can further include a network interface 716 to provide an interface to outside networks, including an interface to a communication network 718, and is coupled via the communication network 718 to corresponding interface devices in other computer systems or machines. The communication network 718 may comprise many interconnected computer systems, machines, and communication links. These communication links may be wired links, optical links, wireless links, or any other devices for communication of information. The communication network 718 can be any suitable computer network, for example a wide area network such as the Internet, and/or a local area network such as Ethernet. The communication network 718 can be wired and/or wireless, and the communication network can use encryption and decryption methods, such as is available with a virtual private network. The communication network uses one or more communications interfaces, which can receive data from, and transmit data to, other systems. Embodiments of communications interfaces typically include an Ethernet card, a modem (e.g., telephone, satellite, cable, or ISDN), (asynchronous) digital subscriber line (DSL) unit, Firewire interface, USB interface, and the like. One or more communications protocols can be used, such as HTTP, TCP/IP, RTP/RTSP, IPX and/or UDP.

As illustrated in FIG. 7, the one or more processors 702, the machine-readable medium 704, the user interface input devices 712, the user interface output devices 714, and/or the network interface 716 can be communicatively coupled to one another using a bus subsystem 720. Although the bus subsystem 720 is shown schematically as a single bus, alternative embodiments of the bus subsystem may use multiple buses. For example, RAM-based main memory can communicate directly with file storage systems using Direct Memory Access (“DMA”) systems.

### Conclusion

The Detailed Description referred to accompanying figures to illustrate exemplary embodiments consistent with the disclosure. References in the disclosure to “an exemplary embodiment” indicates that the exemplary embodiment described can include a particular feature, structure, or characteristic, but every exemplary embodiment may not necessarily include the particular feature, structure, or characteristic. Moreover, such phrases are not necessarily referring to the same exemplary embodiment. Further, any feature, structure, or characteristic described in connection with an exemplary embodiment can be included, independently or in any combination, with features, structures, or characteristics of other exemplary embodiments whether or not explicitly described.

The Detailed Description is not meant to be limiting. Rather, the scope of the disclosure is defined only in accordance with the following claims and their equivalents. It is to be appreciated that the Detailed Description section, and not the Abstract section, is intended to be used to interpret the claims. The Abstract section can set forth one or more, but not all exemplary embodiments, of the disclosure, and thus, are not intended to limit the disclosure and the following claims and their equivalents in any way.

The exemplary embodiments described within the disclosure have been provided for illustrative purposes and are not intended to be limiting. Other exemplary embodiments are possible, and modifications can be made to the exemplary embodiments while remaining within the spirit and scope of the disclosure. The disclosure has been described with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

Embodiments of the disclosure can be implemented in hardware, firmware, software application, or any combination thereof. Embodiments of the disclosure can also be implemented as instructions stored on a machine-readable medium, which can be read and executed by one or more processors. A machine-readable medium can include any mechanism for storing or transmitting information in a form readable by a machine (e.g., a computing circuitry). For example, a machine-readable medium can include non-transitory machine-readable mediums such as read only memory (ROM); random access memory (RAM); magnetic disk storage media; optical storage media; flash memory devices; and others. As another example, the machine-readable medium can include transitory machine-readable medium such as electrical, optical, acoustical, or other forms of propagated signals (e.g., carrier waves, infrared signals, digital signals, etc.). Further, firmware, software application, routines, instructions can be described herein as performing certain actions. However, it should be appreciated that such descriptions are merely for convenience and that such actions in fact result from computing devices, processors, controllers, or other devices executing the firmware, software application, routines, instructions, etc.

The Detailed Description of the exemplary embodiments fully revealed the general nature of the disclosure that others can, by applying knowledge of those skilled in relevant art(s), readily modify and/or adapt for various applications such exemplary embodiments, without undue experimentation, without departing from the spirit and scope of the disclosure. Therefore, such adaptations and modifications are intended to be within the meaning and plurality of equivalents of the exemplary embodiments based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

What is claimed is:

1. A method for providing a monitor audio mix to a performer within a venue, the method comprising:
determining, by a monitor audio mix server, a location of the performer within the venue;
identifying, by the audio mix server, a virtual audio zone within the venue that corresponds to the location;
determining, by the audio mix server, a plurality of parameters, characteristics, or attributes for a plurality of soundwaves to be emitted by one or more monitor speaker arrays to provide the monitor audio mix to the virtual audio zone; and
providing, by the audio mix server, the plurality of soundwaves to the one or more monitor speaker arrays to provide the monitor audio mix to the virtual audio zone.

2. The method of claim 1, wherein the determining the location comprises determining the location of the performer within the venue during an event being hosted by the venue.

3. The method of claim 2, wherein the determining the location of the performer within the venue during the event comprises determining the location of the performer with the venue at discrete intervals in time during the event.

4. The method of claim 1, wherein the identifying comprises:
segmenting the venue into a plurality of virtual audio zones; and
selecting the virtual audio zone from among the plurality of audio zones that includes the location.

5. The method of claim 1, wherein the determining the plurality of parameters, characteristics, or attributes for the plurality of soundwaves comprises determining a plurality of phases or amplitudes for the plurality of soundwaves to be emitted by one or more monitor speaker arrays to provide the monitor audio mix.

6. The method of claim 5, wherein the determining the plurality of phases or amplitudes for the plurality of soundwaves comprises querying a database with the virtual audio zone to return the plurality of phases or amplitudes for the plurality of soundwaves.

7. The method of claim 1, wherein the plurality of soundwaves comprises vocals, instruments, backing tracks, click tracks, or other vocals and instruments to be heard by the performer during the event.

8. A monitor audio mix server for providing a monitor audio mix to a performer within a venue, the monitor audio mix server comprising:
a memory configured to instructions; and
a processor configured to execute the instructions, the instructions, when executed by the processor, configuring the processor to:
determine a location of the performer within the venue,
identify a virtual audio zone within the venue that corresponds to the location,
determine a plurality of parameters, characteristics, or attributes for a plurality of soundwaves to be emitted by one or more monitor speaker arrays to provide the monitor audio mix to the virtual audio zone, and
provide the plurality of soundwaves to the one or more monitor speaker arrays to provide the monitor audio mix to the virtual audio zone.

9. The monitor audio mix server of claim 8, wherein the instructions, when executed by the processor, configure the processor to determine the location of the performer within the venue during an event being hosted by the venue.

10. The monitor audio mix server of claim 9, wherein the instructions, when executed by the processor, configure the processor to determine the location of the performer with the venue at discrete intervals in time during the event.

11. The monitor audio mix server of claim 8, wherein the instructions, when executed by the processor, configure the processor to:
segment the venue into a plurality of virtual audio zones; and
select the virtual audio zone from among the plurality of audio zones that includes the location.

12. The monitor audio mix server of claim 8, wherein the instructions, when executed by the processor, configure the processor to determine a plurality of phases or amplitudes for the plurality of soundwaves to be emitted by one or more monitor speaker arrays to provide the monitor audio mix.

13. The monitor audio mix server of claim 12, wherein the instructions, when executed by the processor, configure the processor to query a database with the virtual audio zone to return the plurality of phases or amplitudes for the plurality of soundwaves.

14. The monitor audio mix server of claim 8, wherein the plurality of soundwaves comprises vocals, instruments, backing tracks, click tracks, or other vocals and instruments to be heard by the performer during the event.

15. A monitor audio mix system for providing a monitor audio mix to a performer within a venue, the monitor audio mix system comprising:
a plurality of monitor speaker arrays; and
a monitor audio mix server configured to
determine a location of the performer within the venue,
identify a virtual audio zone within the venue that corresponds to the location,
determine a plurality of phases or amplitudes for a plurality of soundwaves to be emitted by one or more monitor speaker arrays from among the plurality of monitor speaker arrays to provide the monitor audio mix to the virtual audio zone, and
provide the plurality of soundwaves to the one or more monitor speaker arrays to provide the monitor audio mix to the virtual audio zone.

16. The monitor audio mix system of claim 15, wherein the monitor audio mix server is configured to determine the location of the performer within the venue during an event being hosted by the venue.

17. The monitor audio mix system of claim 16, wherein the monitor audio mix server is configured to determine the location of the performer with the venue at discrete intervals in time during the event.

18. The monitor audio mix system of claim 15, wherein the monitor audio mix server is configured to:
segment the venue into a plurality of virtual audio zones; and
select the virtual audio zone from among the plurality of audio zones that includes the location.

19. The monitor audio mix system of claim 18, wherein the monitor audio mix server is configured to query a database with the virtual audio zone to return the plurality of phases or amplitudes for the plurality of soundwaves.

20. The monitor audio mix system of claim 15, wherein the plurality of soundwaves comprises vocals, instruments, backing tracks, click tracks, or other vocals and instruments to be heard by the performer during the event.
